(19) United States
(12) Patent Application Publication
(10) Pub. No.: US 2003/0171487 A1
(43) Pub. Date: Sep. 11, 2003

(54) Curable silicone gum thermal interface material

(75) Inventors: Mark W. Ellsworth, Dublin, CA (US); Miguel A. Morales, Fremont, CA (US); Richard B. Lloyd, Sunnyvale, CA (US)

Correspondence Address: Tyco Electronics Corporation, Intellectual Property Law Dept., 307 Constitution Drive, MS R20/1B, Menlo Park, CA, 94025-1164, US

(73) Assignee: Tyco Electronics Corporation

(21) Appl. No.: 10/213,673

(22) Filed: Aug. 6, 2002

Related U.S. Application Data
(60) Provisional application No. 60/363,666, filed on Mar. 11, 2002.

(51) Int. Cl. C08L 83/00

(52) U.S. Cl. 524/588

(57) ABSTRACT

A high viscosity, cured silicone-based thermal interface material is disclosed. The thermal interface material adapts readily to conform to heat transfer surfaces. For example, the thermal interface material is placed between a heat source, such as a central processing unit (CPU) of a computer, and a heat sink attached to the CPU. In use, the thermal interface material absorbs the heat from the CPU and transfers the heat to the heat sink, thereby cooling the CPU. The material has high rates of heat transfer, as measured by low thermal resistance and high thermal conductivity.

This application claims priority to Provisional Application 60/363,666, filed on Mar. 11, 2002, which is hereby incorporated by reference in its entirety.

### FIELD OF THE INVENTION

This invention relates to a thermal interface material useful in transferring heat from a heat source to a heat sink. In particular, the invention relates to curable polymer thermal interface materials that conform readily to the surfaces of heat sources and sinks.

### BACKGROUND OF THE INVENTION

In spite of the many advances made in electronics, integrated circuits, and microelectronics, some persistent problems remain. One problem that affects manufacturers and users alike is heat transfer. As thousands of transistors and their associated circuitry are squeezed into smaller and smaller areas on microchips, the heat generated increases exponentially. Even though each circuit is smaller, each generates heat. The heat must be transferred to a heat sink or otherwise dissipated or the microchip temperature will rise to an unacceptably high level. This problem occurs in the central processing unit (CPU) of a computer, particularly a desk-top or laptop microcomputer, such as those using Intel Pentium® or other very-high density chips.

Many ways have been devised to cope with the problem of transferring heat from integrated circuits or chips. For example, “pillows” filled with heat transfer materials have been used. In addition, metal heat exchangers with liquid or gas flowing internally also have been used. More recently, thermal interface materials (“TIMs”) such as thermal greases, phase change materials (“PCMs”), and elastomeric pads have been used to dissipate heat in computers.

A thermal interface material is generally a composition that is placed between a heat generating source and a heat sink or other dissipation device to facilitate efficient heat transfer between the heat source and the heat sink. For example, in a computer, a TIM is placed between the CPU and a finned aluminum heat sink. In the absence of a TIM, air gaps may exist between the CPU (heat source) and the heat sink, limiting the flow of heat from source to sink.

One type of TIM is a thermal grease which is typically composed of silicone oil or mineral oil, filled with a high thermal conductivity ceramic or metal powder, such as zinc oxide, aluminum oxide, silver or aluminum. Thermal greases are generally low viscosity silicone oils or hydrocarbon oils, often with one or more fillers having high thermal conductivity. In use, thermal greases have a paste-like consistency and are applied as a bead or film from a tube or syringe to the CPU, which is then fastened to a finned aluminum heat sink. As the CPU and heat sink are joined, the grease is spread into a thin layer or film between the CPU and the heat sink. Because of the great pressure applied to encourage thermal contact (70-80 psi) between the CPU and the heat sink, the grease can be spread to a film thickness less than about 0.025 mm (approx 0.001 in.). The result is a very thin, air-gap-free interface of very low thermal resistance. Despite these advantages, thermal greases can be difficult to work with. The grease can be physically transferred to other circuitry during assembly, resulting in circuitry failures. Moreover, these greases can be messy to work with, and are not easy to apply uniformly without gaps. They also suffer from a phenomenon know as “bleed-out,” in which their volatile components escape during repeated use. The thermal grease, therefore, is able to transfer less and less heat over time. Finally, if the CPU and heat sink need to be taken apart, removal and cleaning of the thermal grease before reassembly can be difficult and time consuming.

Another type of TIM which is often used is a phase change material (PCM) which undergoes a phase change from solid wax to liquid wax, and then back to solid during installation and during operation. Examples of PCMs include paraffin waxes, which often contain a ceramic or metal powder filler having high thermal conductivity. Unfortunately, these materials typically require a high-temperature “reflow” for installation, which can be harmful to the microchip needed to be cooled. The phase change, and thus the heat transfer, also may not occur at precisely the desired temperature, thus limiting the utility of the phase change material.

PCMs are supplied as thin films (0.075 to 0.15 mm thick, 0.003 to about 0.006 inches thick). Similar to thermal greases, the thin film is placed between the CPU and the heat sink. According to PCM manufacturers, powering the CPU causes it to heat up to a temperature above the melting point of the wax, about 55° C. (about 131° F.). The wax then melts to a liquid state, allowing the wax material to fill gaps and to compress to a thinner film from the force of the CPU-heat sink assembly. Once the material has flowed and conformed to the surfaces, the CPU temperature drops below the melting point of the wax due to more efficient heat transfer to the heat sink, and returns to a solid state. One disadvantage of PCMs is that the installation procedure is difficult. In order to melt and fill the gaps as indicated above, a “reflow” step must be incorporated into assembly of the computer. A subassembly of the CPU, the PCM, and the heat sink must be placed into an oven and heated to 60-70° C. (140-1 58° F.) to melt and properly “install” the PCM. Only then can the CPU be installed into a computer with an expectation of good heat transfer. Of course, adding any step to assembly adds to the assembly time for the computer and, in turn, raises the cost. Another difficulty is that once this assembly is made, disassembly can only be accomplished by aggressive scraping of the wax from the CPU, or using solvents, both of which may damage either the CPU or the heat sink surface.

Elastomeric pads are also useful in transferring heat in electronic devices. These pads are typically made of a low durometer silicone rubber and fillers having high thermal conductivity. The pads conform under pressure accommodating uneven surfaces of a microchip (heat source) and the heat sink to which heat is being transferred. However, these pads have limited compressibility and their ability to conform to small, irregular surfaces is often insufficient for satisfactory heat transfer. The present invention is directed at correcting these deficiencies in the prior art.

### SUMMARY

One aspect of the present invention provides a silicone-based thermal interface material. The material comprises from about thirty-three to about sixty-six parts by weight of a vinyl-terminated polydimethylsiloxane having a functionality of two or less. The material also comprises from about one to about sixty-six parts by weight of a hydride terminated polydimethylsiloxane having a functionality of two or less. In addition, the material also may comprise from about zero to about twenty parts by weight of a coupling agent and from about zero to two parts by weight of a catalyst. The vinyl-terminated polydimethylsiloxane, the hydride-terminated polydimethylsiloxane, the coupling agent, if any, and the catalyst, if any, are mixed together and cured to form a high-viscosity silicone-based thermal interface material.

Another aspect of the present invention is a method of making a silicone-based thermal interface material. The method comprises providing from about thirty-three to about sixty-six parts by weight of a vinyl-terminated polydimethylsiloxane having a functionality of two or less and providing from about one to about sixty-six parts by weight of a hydride terminated polydimethylsiloxane having a functionality of two or less. The method further comprises providing from about zero to about twenty parts by weight of a coupling agent, from about zero parts to about five parts by weights of a curing decelerator, and from about zero to about two parts by weight of a catalyst. The vinyl-terminated polydimethylsiloxane, hydride terminated polydimethylsiloxane, the coupling agent, if any, and the catalyst, if any, and decelerator, if any, are then combined to form a mixture. The method further comprises forming a film from the mixture and curing the film.

Other systems, methods, features, and advantages of the present invention will become apparent to one skilled in the art upon examination of the following figures and detailed description. All such additional systems, methods, features, and advantages are intended to be included within this description, within the scope of the invention, and protected by the accompanying claims.

### BRIEF DESCRIPTION OF THE FIGURES

The invention may be better understood with reference to the following figures and detailed description.

FIG. 1 depicts two principal components of the silicone gum pads.

FIGS. 2-3 are graphs depicting thermal performance and softness (cone penetration) of TIM pads.

FIG. 4 is a graph depicting thermal performance parameters of the TIM pads.

FIG. 5 is a graph correlating thermal resistance and viscosity of the TIM pads.

FIGS. 6 and 8 are charts comparing CPU temperature for a CPU in thermal contact with a thermally conductive material.

FIG. 7 is a graph comparing thermal resistance and applied pressure for a variety of materials.

### DETAILED DESCRIPTION OF THE PRESENTLY PREFERRED EMBODIMENTS

A material has been developed that can be made into a thin film which is then cured, resulting in a high viscosity thermal interface material. The thermal interface material includes reactive silicone intermediates and may also include a thermally conductive ceramic or metal filler material. Before curing, the silicone-based material has a low viscosity, preferably less than 100,000 cps. The uncured material may be cast into a film, stencil printed or screen printed onto a transfer film, doctor-bladed onto a release paper or decal paper, or spread or directly deposited onto a heat sink or heat spreader. The uncured material may also be formed into a film by other methods, such as blading or spreading with a squeegee or hand-held tool. After the thermal interface material is cured, the material has a viscosity greater than 1,000,000 cps, which prevents “bleed-out” of the constituent materials at high temperatures and pressures.

Even though the material is cured, it is not a crosslinked solid. Under pressure, the material still flows sufficiently to readily conform to the heat source and sink and to form a very thin interface between the two. In general, the cured material of the present invention conforms as well to the heat source and sink as thermal grease, but does not have the handling and “bleed-out” problems of grease. Moreover, the cured material of the present invention has the handling properties of a solid thermal gel or a thermal phase change material, but conforms more readily than gels or phase change materials. Such conformability is achieved by eliminating cross-linking as much as possible in the polymeric system used for the material. Since cross linking is only possible in polymers that have more than two reactive sites, the silicone polymers chosen for this application are limited to those having two or fewer reactive sites per monomer. Thus, the monomers used in the present invention are capable of linking only two other monomers. In one embodiment, the silicone monomer end sites are the reactive or linking sites.

The thermal interface material of present invention comprises silicone polymers, including a vinyl-terminated polydimethylsiloxane (PDMS) and a hydride-terminated polydimethylsiloxane and may include a coupling agent, a catalyst, a decelerator, and a thermally conductive filler. Each of these components will be discussed below.

Silicone Polymers

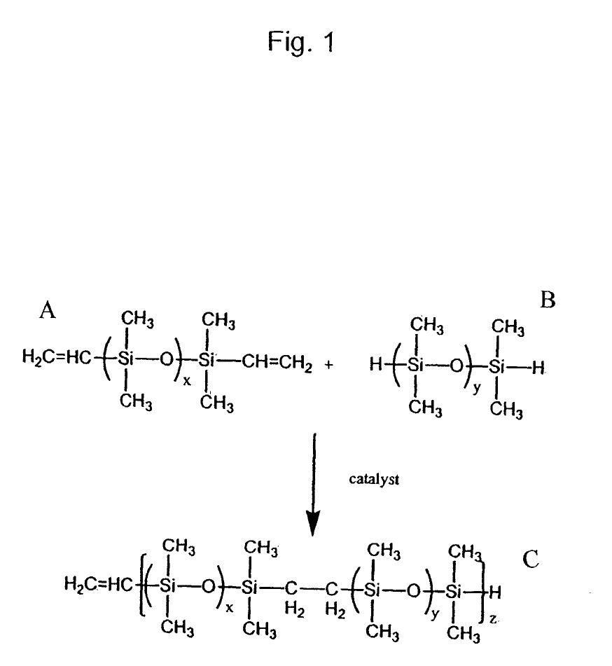

FIG. 1 illustrates the structure of a vinyl-terminated polydimethylsiloxane A and a hydride-terminated polydimethylsiloxane B, which are suitable for use in the thermal interface material of the present invention. Each of these polymers has a functionality of two or less and a molecular weight from about 200 amu to about 200,000 amu. More preferably the vinyl-terminated PDMS polymers have a molecular weight from about 10,000 to about 30,000 amu, and most preferably about 17,000 amu. Hydride-terminated PDMS polymers, also with a functionality of two or less, may range in molecular weight from about 200 to about 200,000 amu, and preferably from about 400 to 700 amu. Additionally, silanol-terminated polydimethylsiloxanes having a functionality of two or less may also be used. The molecular weight of these silanol-terminated PDMS polymers may vary from about 200 to 200,000 amu, and in one embodiment is from about 4000 to about 6000 amu. Each of these polymers has sufficient strength and stability in the desired temperature range, room temperature up to about 150° C. Silicone polymers are available commercially from Gelest Inc., Morrisville, Pa.

In one embodiment, the silicone polymers have relatively low molecular weights, such that x equals about 300 and y equals about 10, and a linear polymer C shown in FIG. 1 is produced, such that z equals about 10,000. The stoichiometry of the vinyl-terminated and hydride terminated components is important in determining the viscosity of the resulting silicone gum after the components have been cured. While any stoichiometry is theoretically possible, Table 1 below shows a range of hydride to vinyl stoichiometries that have been found useful and practical in formulating the silicone gum polymers of the present invention. As shown in Table 1, ratios of hydride to vinyl-terminated polymer greater than 0.75 provide the highest viscosity silicone gum polymers.

TABLE 1

| Hydride To Vinyl | Viscosity of Cured Mixture |
|---|---|
| Stoichiometry | In cps |
| 0.67 | 6,000 |
| 0.74 | 9,000 |
| 0.82 | 80,000 |
| 0.91 | 90,000 |
| 0.98 | 700,000 |
| 1.08 | 1,000,000,000 |
| 1.13 | 850,000,000 |
| 1.24 | 900,000 |

Coupling Agents

The thermal interface material of the present invention may also comprise a relatively small amount of a coupling agent. In one embodiment, the coupling agent is a silanol-terminated polymer. While these polymers are not an addition-type polymeric species, they act as an interface or coupling agent with the thermally-conductive additives that make the silicone gum materials more effective. Other coupling agents that may be used include, but are not limited to, silane, titanate, and zirconate coupling agents, and organic acids. Silane coupling agents have the general formula R₁R₂R₃—Si—R, where R₁, R₂ and R₃ are typically methoxy or ethoxy, but may also be methyl or even 2-methoxyethoxy, and R is alkyl, phenyl, or fluoroalkyl. Silane coupling agents more typically have the formula (CH₃O)₃—Si—R, where R is alkyl, phenyl, or fluoroalkyl. Silane coupling agents may have tri-methoxy or tri-ethoxy functionality, or even mixed functions, such a diethoxymethyl (and another functional group) or dimethoxymethyl (and another functional group). Examples of silane coupling agents suitable for use in the present invention include, but are not limited to, methyltrimethoxysilane, octyltrimethoxysilane, phenyltrimethoxysilane, and trifluoropropyltrimethoxysilane.

In addition, R may be a substituted alkyl, phenyl, or fluoroalkyl, wherein the substitution includes amino, sulfur, epoxy, chloro, methacryl and vinyl. Examples of suitable substituted silane coupling agents include aminopropyltrimethoxysilane, chloromethyltrimethoxysilane, chloropropyltriethoxysilane, aminoethylaminopropyltrimethoxysilane, diethylenetriaminopropyltrimethoxysilane, cyclohexylaminopropyltrimethoxysilane, hexanediaminomethyltrimethoxysilane, anilinomethyltriethoxysilane, (diethylaminomethyl)methyldiethoxysilane, mercaptopropyltrimethoxysilane, bis(triethoxysilylpropyl)tetrasulfide, glycidoxypropyltrimethoxysilane, glycidoxypropyltriethoxysilane, glycidoxypropylmethyldiethoxysilane, glycidoxypropylmethyltrimethoxysilane, vinyltriethoxysilane, and methacryloxypropyltrimethoxysilane. Silane coupling agents are available commercially from Gelest, Inc., Morrisville, Pa., and Power Chemical Co., Nanjing, Jiangsu, China.

Titanate coupling agents have the general formula (RO)₄Ti, where R is alkyl, phenyl, or fluoroalkyl and includes tetra-n-butyltitanate and tetra-isopropyl-titanate. The alkyls may be straight chain, branched, or cyclic, and may also be have functional substitutions, such as ethanolamine. Zirconate coupling agents are of the general formula (RO)₄Zr, where R is alkyl, phenyl, or fluoroalkyl and include zirconium isopropoxide and tetra-n-butyl zirconate. Triethanolamine zirconate and triethanolamine titanate may also be used as coupling agents. Titanate and zirconate coupling agents are available commercially from Kenrich Petrochemical Inc., Bayonne, N.J.

In addition, organic acids may also be used as coupling agents. These acids have the general formula R—CO₂—H, where R is typically an alkyl or aryl. Examples of suitable organic acids include stearic acid, propionic acid, and benzoic acid. These acids are available commercially from Aldrich Chemical Co., Milwaukee, Wis.

Catalysts

The thermal interface material of the present invention also may comprise a catalyst in order to cause addition reactions within a reasonably short time at mildly elevated temperatures, from room temperatures up to about 150° C. (302° F.). Suitable catalysts include, but are not limited to, tris-(dibutylsulfide) rhodium trichloride, platinum-octanaldehyde/octanol complex; platinum carbonyl cyclovinylmethylsiloxane complex, chloroplatinic acid (Karsted's catalyst), platinum-divinyltetramethyldisiloxane complex, and platinum-cyclovinylmethylsiloxane complex. These catalysts are available commercially from Gelest, Inc, Morrisville, Pa. The catalyst may be present in an amount from about 0.0 weight percent to about 2 weight percent. In one embodiment, the catalyst is present in the amount of 0.05 to 2 weight percent. In another embodiment the catalyst is a platinum-divinyltetramethyldisiloxane complex and is present in an amount of about 0.1 weight percent in Part A only, as described in the examples below. The platinum itself may be present in an amount of 5 to 10 parts per million in Part A. Those of ordinary skill in the art will appreciate that higher or lower concentrations of the catalyst may also be used.

Decelerators

In addition to the silicone polymer, coupling agents, and catalysts, the thermal interface material of the present invention also may include a decelerator or retarder.

These decelerators retard the curing reaction and provide longer shelf life. Suitable decelerators or retarders include, but are not limited to, diallyl maleate, 1,3-divinyltetramethyldisiloxane, 3,5-dimethyl-1-hexyn-3-ol, and 1,3,5,7-tetravinyl-1,3,5,7-tetramethylcyclotetrasiloxane. These decelerators or retarders are available commercially from Aldrich Chemical Company, Milwaukee, Wis. The decelerator may be present from 0.0 weight percent to about 5.0 weight percent. In one embodiment, the decelerator is 3,5-dimethyl-1-hexyn-3-ol, and is present in about 0.1 weight percent in Part B only, as described in the examples below.

Thermal Conductivity Fillers

Finally, the thermal interface material of the present invention may comprise chemically inert components to raise the thermal conductivity of the resulting material. These thermally conductive fillers may include any ceramic or metal powder that will raise thermal conductivity without interfering with the chemical reactions of the silicone materials. Suitable ceramic materials include aluminum oxide (alumina), silicon carbide, silicon nitride, graphite, boron nitride, silica, such as fumed silica, zinc oxide, and silicon powder. Metallic powders may include silver, aluminum and copper. As discussed above, a coupling agent may be used to aid in incorporation of these particulates into the silicone gum.

Because of the density differences between the thermally conductive fillers and the silicone gums, it makes more sense to speak of a volume fraction or a volume percent than a weight percent. Conductive materials may usefully be added in an amount from 0 to 80 volume percent, and preferably from about 20 to about 60 volume percent of the resulting thermal interface material. In one embodiment, boron nitride with a median particle size of about 100 micrometers, with a majority of the particles being between 30 and 150 micrometers, has been particularly suitable. In another embodiment, aluminum oxide powder having a particle size from about 1 micrometer to about 60 micrometers has also has provided excellent thermal conductivity, as has aluminum metal powder having a particle size from about 1 to about 5 micrometers. These materials are available from a number of suppliers worldwide.

Viscosity of the Thermal Interface Material

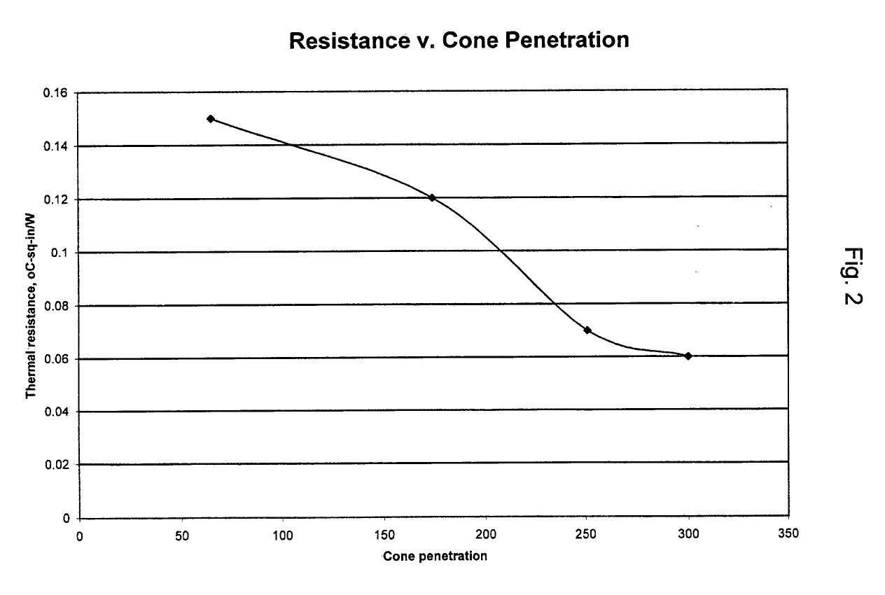

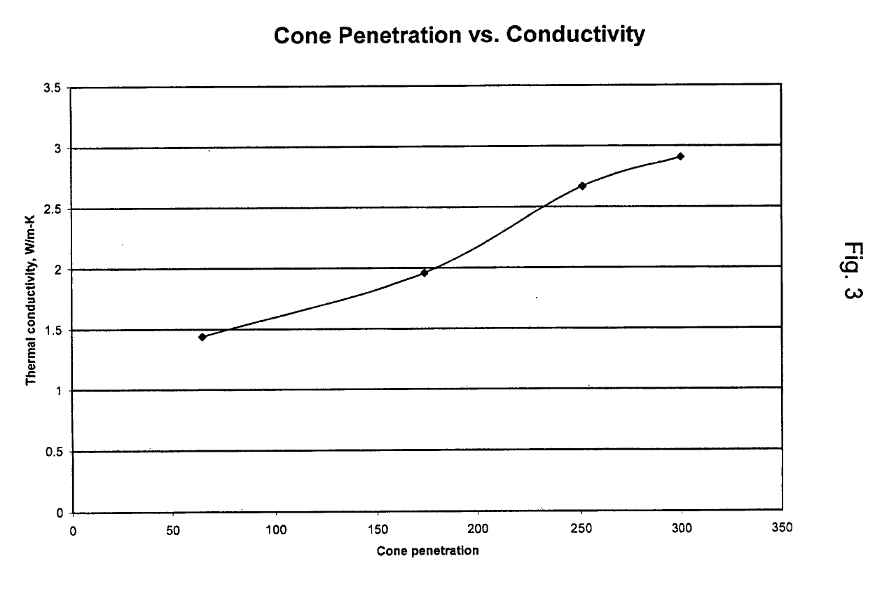

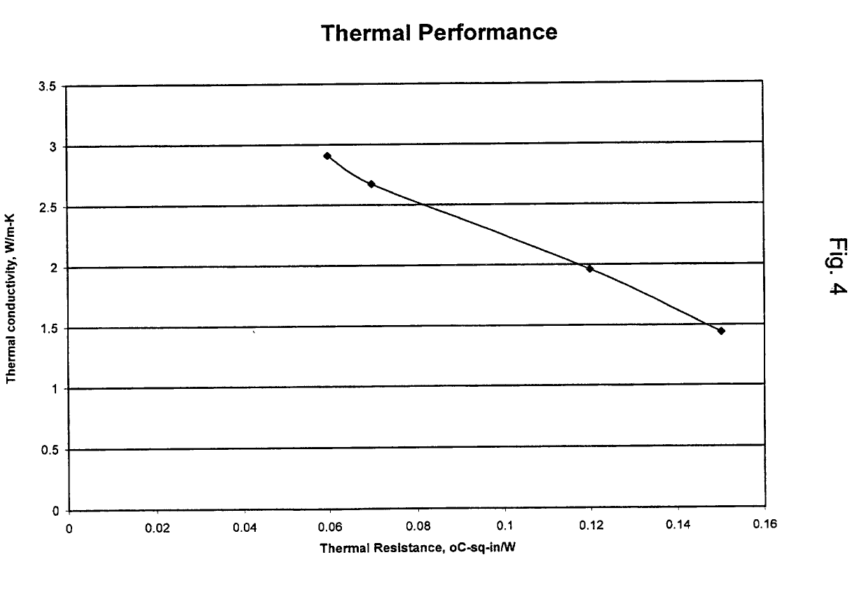

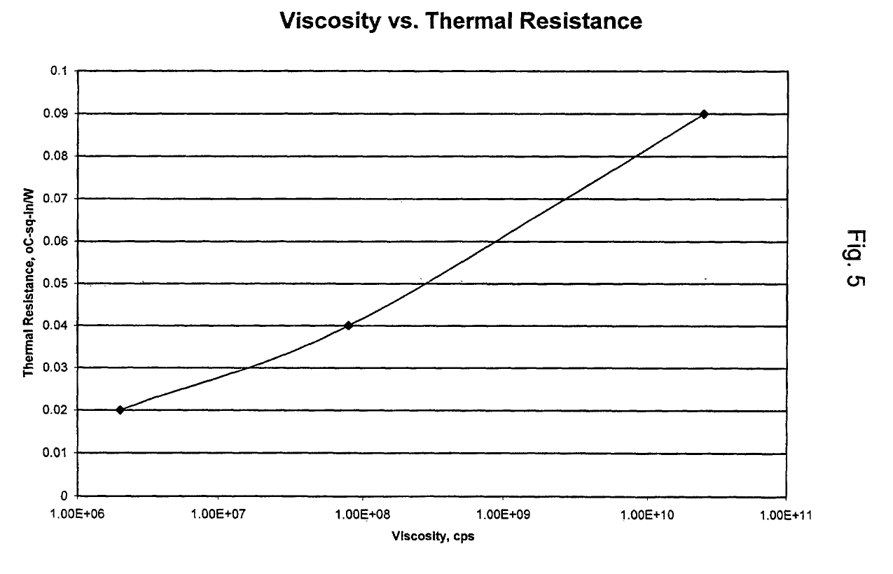

The viscosity of the resulting silicone gum thermal interface material after curing is much greater than that of the pre-cured material. However, the cured materials are very soft and conformable, and in fact are typically not measurable with standard Durometer equipment, such as an “A” scale Durometer. Viscosity is measured using a Brookfield rotational viscometer, according to ASTM D 2196, Method A. The hardness of the thermal interface material of the present invention may also be measured with a cone penetration test, according to ASTM D 217. FIG. 2 demonstrates the inverse correlation of thermal resistance with cone penetration for pads formed from the thermal interface material of the present invention. That is, the greater the cone penetration (and the greater the conformability of the silicone gum material), the lower its thermal resistance. Cone penetration of pads made from the thermal interface material of the present invention was also determined and measured against thermal conductivity, as shown in FIG. 3. The greater the cone penetration, that is, the greater the conformability of the silicone gum material, the greater its thermal conductivity. FIG. 4 illustrates a comparison of thermal conductivity versus thermal resistance, the two primary means for measuring thermal performance, of pads made from the thermal interface material of the present invention. Thermal conductivity generally measures nothing but the thermal conductivity of the material itself, while thermal resistance is a measure of the total performance of the interface material, and includes the effect of both interfaces of the conductive material, as well as the thermal conductivity of the material itself. As expected, greater thermal conductivity correlates with lesser degrees of thermal resistance in testing with the silicone gum embodiments of thermal interface material. FIG. 5 demonstrates that the lower the cured viscosity of pads made from the thermal interface material of the present invention, the lower the thermal resistance, all other conditions being equal. A number of examples of thermal interface materials of the present invention are set forth below. In all the following examples, quantities are given in parts by weight unless otherwise stated.

### EXAMPLE NO. 1

SILICONE #1—Part A and PRECURSOR #1—Part A

In a first plastic beaker, 99.9 parts vinyl-terminated PDMS (viscosity, 500 cps; molecular weight, 13,000) and 0.1 parts platinum-vinylsiloxane complex (2% Pt concentration) are combined. The components are mixed with an overhead mixer for 3 minutes to form SILICONE #1—Part A. Forty-nine parts SILICONE #1—Part A are added to 50 parts of boron nitride powder having a median particle size of 100 microns and 1 part silanol-terminated PDMS (viscosity, 100 cps). The components are mixed with a double planetary mixer with vacuum de-aeration for 20 minutes to form PRECURSOR #1—Part A. The viscosity of PRECURSOR #1—Part A is measured using a Brookfield viscometer according to ASTM D 2196, Method A, spindle #7, 20 rpm and is 13,000 cps.

SILICONE #1—Part B and PRECURSOR #1—Part B

In a second plastic beaker, 92.2 parts by weight vinyl-terminated PDMS (viscosity, 500 cps; molecular weight, 13,000), 7.7 parts by weight hydride terminated PDMS (viscosity, 3 cps, molecular weight 500), and 0.1 parts by weight 3,5-dimethyl-1-hexyn-3-ol are combined. The components are mixed with an overhead mixer for 3 minutes to form SILICONE #1—Part B.

Forty-nine parts of SILICONE #1—Part B are added to 50 parts of boron nitride powder with a median particle size of 100 microns and 1 part silanol terminated PDMS (viscosity, 100 cps). The components are mixed with a double planetary mixer with vacuum de-aeration for 20 minutes to form PRECURSOR #1—Part B. The viscosity of PRECURSOR #1—Part B is measured with a Brookfield viscometer according to ASTM D 2196, Method A, spindle #7, 20 rpm and is 10,100 cps.

Equal parts of PRECURSOR #1—Part A and PRECURSOR #1—Part B are then mixed using a hand-held static mixer. The mixed material is coated onto waterslide decal paper using a doctor blade coater to a nominal film thickness of 0.18 mm (0.007 in.). The film is cured at 90° C. for 5 minutes in a forced air circulating oven to form TIM #1.

A sample of TIM #1 is prepared for cone penetration testing according to ASTM D 217 by mixing 50 parts PRECURSOR #1—Part A and 50 parts PRECURSOR #—Part B in a plastic beaker with an overhead mixer for 3 minutes followed by vacuum de-aeration. The material is poured into a 200 cc metal container and cured at 90° C. for 60 minutes in a forced air circulating oven. On testing, the cone penetration of TIM #1 is 300.

### EXAMPLE NO. 2

SILICONE #2—Part A and SILICONE PRECURSOR #2—Part A

In a first plastic beaker, 99.9 parts vinyl-terminated PDMS (viscosity, 500 cps; molecular weight 13,000) and 0.1 parts platinum-vinylsiloxane complex (2% Pt concentration) are combined. The components are mixed with an overhead mixer for 3 minutes to form SILICONE #2—Part A. Forty-nine parts of SILICONE #2—Part A are added to 50 parts by weight boron nitride powder with a median particle size of 100 microns and 1 part silanol-terminated PDMS (viscosity, 100 cps). The components are mixed with a double planetary mixer with vacuum de-aeration for 20 minutes to form PRECURSOR #2—Part A. A Brookfield viscometer is used to determine the viscosity of PRECURSOR #2—Part A according to ASTM D 2196, Method A, spindle #7, 20 rpm and is determined to be 13,000 cps.

SILICONE #2—Part B and SILICONE PRECURSOR #2—Part B

In a second plastic beaker, 91.8 parts vinyl-terminated PDMS (viscosity, 500 cps; molecular weight, 13,000), 8.1 parts hydride-terminated PDMS (viscosity, 3 cps; molecular weight 500), and 0.1 parts 3,5-dimethyl-1-hexyn-3-ol are combined. The ingredients are mixed with an overhead mixer for 3 minutes to form SILICONE #2—Part B.

Forty-nine parts of SILICONE #2—Part B are added to 50 parts by weight boron nitride powder with a median particle size of 100 microns and 1 part silanol terminated PDMS (viscosity, 100 cps). The components are mixed with a double planetary mixer with vacuum de-aeration for 20 minutes to form PRECURSOR #2—Part B. The viscosity of PRECURSOR #2—Part B is measured with a Brookfield viscometer according to ASTM D 2196, Method A, spindle #7, 20 rpm and is 10,000 cps.

Equal parts of PRECURSOR #2—Part A and PRECURSOR #2—Part B are mixed using a hand-held static mixer. The mixed material was coated onto waterslide decal paper using a doctor blade coater to a nominal film thickness of 0.18 mm (0.007 in.). The film is cured at 90° C. for 5 minutes in a forced air circulating oven to form TIM #2.

A sample of TIM #2 is prepared for cone penetration testing according to ASTM D 217 by mixing 50 parts PRECURSOR #2—Part A and 50 parts PRECURSOR #2—Part B in a plastic beaker with an overhead mixer for 3 minutes followed by vacuum de-aeration. The material is poured into a 200 cc metal container and cured in a forced air circulating oven at 90° C. for 60 minutes. The cone penetration of TIM #2 is 251.

### EXAMPLE NO. 3

SILICONE #3—Part A and SILICONE PRECURSOR #3—Part B

In a first plastic beaker, 99.9 parts vinyl terminated PDMS (viscosity 500 cps; molecular weight, 13,000) and 0.1 parts platinum-vinylsiloxane complex catalyst (2% Pt concentration) are combined. The components are mixed with an overhead mixer for 3 minutes to form SILICONE #3—Part A. Forty-nine parts of SILICONE #3—Part A are added to 50 parts by weight boron nitride powder with a median particle size of 100 microns and 1 part silanol terminated PDMS (viscosity, 100 cps). The components are mixed with a double planetary mixer with vacuum de-aeration for 20 minutes to form PRECURSOR #3—Part A. The viscosity of PRECURSOR #3—Part A is measured using a Brookfield viscometer according to ASTM D 2196, Method A, spindle #7, 20 rpm and is 13,000 cps.

SILICONE #3—Part B and SILICONE PRECURSOR #3—Part B

In a second plastic beaker, 91.4 parts vinyl terminated PDMS (viscosity, 500 cps; molecular weight, 13,000), 8.5 parts hydride-terminated PDMS (viscosity, 3 cps; molecular weight, 500), and 0.1 parts 3,5-dimethyl-1-hexyn-3-ol inhibitor are combined. The ingredients are mixed with an overhead mixer for 3 minutes to form SILICONE #3—Part B. Forty-nine parts of SILICONE #3—Part B are added to 50 parts boron nitride powder with a median particle size of 100 microns and 1 part silanol terminated PDMS (viscosity, 100 cps). The components are mixed with a double planetary mixer with vacuum de-aeration for 20 minutes to form PRECURSOR #3—Part B. The viscosity of PRECURSOR #3—Part B is measured with a Brookfield viscometer according to ASTM D 2196, Method A, spindle #7, 20 rpm and is 10,500 cps.

Equal parts of PRECURSOR #3—Part A and PRECURSOR #3—Part B then are mixed using a hand-held static mixer. The mixed material is coated onto waterslide decal paper using a doctor blade coater to a nominal film thickness of 0.18 mm (0.007 in.). The film is cured at 90° C. for 5 minutes in a forced air circulating oven to form TIM #3.

A sample of TIM #3 is prepared for cone penetration testing according to ASTM D 217 by mixing 50 parts PRECURSOR #3—Part A and 50 parts PRECURSOR #3—Part B in a plastic beaker with an overhead mixer for 3 minutes followed by vacuum de-aeration. The material is poured into a 200 cc metal container and cured at 90° C. for 60 minutes. The cone penetration of TIM #3 is 174.

### EXAMPLE NO. 4

SILICONE #4—Part A and SILICONE PRECURSOR #4—Part A

In a first plastic beaker, 99.9 parts vinyl-terminated PDMS (viscosity 500 cps; molecular weight, 13,000 amu) and 0.1 parts platinum-vinylsiloxane complex (2% Pt concentration) are combined. The components are mixed with an overhead mixer for 3 minutes to form SILICONE #4—Part A. Forty-nine parts SILICONE #4—Part A are added to 50 parts boron nitride powder with a median particle size of 100 microns and 1 part silanol-terminated PDMS (viscosity, 100 cps). The components are mixed with a double planetary mixer with vacuum de-aeration for 20 minutes to form PRECURSOR #4—Part A. The viscosity of PRECURSOR #4—Part A is measured using a Brookfield viscometer according to ASTM D 2196, Method A, spindle #7, 20 rpm and is 13,000 cps.

SILICONE #4—Part B and SILICONE PRECURSOR #4—Part B

In another plastic beaker, 91.0 parts vinyl terminated PDMS (viscosity, 500 cps, molecular weight 13,000), 8.9 parts hydride-terminated PDMS (viscosity, 3 cps, molecular weight 500), and 0.1 parts 3,5-dimethyl-1-hexyn-3-ol are combined. The ingredients are mixed with an overhead mixer for 3 minutes to form SILICONE #4—Part B. Forty-nine parts SILICONE #4—Part B are added to 50 parts boron nitride powder with a median particle size of 100 microns and 1 part silanol-terminated PDMS (viscosity, 100 cps). The components are mixed with a double planetary mixer with vacuum de-aeration for 20 minutes to form PRECURSOR #4—Part B. The viscosity of PRECURSOR #4—Part B is measured with a Brookfield viscometer according to ASTM D 2196, Method A, spindle #7, 20 rpm and is 10,600 cps.

Equal parts of PRECURSOR #4—Part A and PRECURSOR #4—Part B are mixed using a hand-held static mixer. The mixed material is coated onto waterslide decal paper using a doctor blade coater to a nominal film thickness of 0.18 mm (0.007 in.). The film is cured at 90° C. for 5 minutes in a forced air circulating oven to form TIM #4.

A sample of TIM #4 is prepared for cone penetration testing according to ASTM D 217 by mixing 50 parts PRECURSOR#4—Part A and 50 parts PRECURSOR #4—Part B in a plastic beaker with an overhead mixer for 3 minutes followed by vacuum de-aeration. The material is poured into a 200 cc metal container and cured at 90° C. for 60 minutes. The cone penetration of TIM #4 is 65.

Testing Procedures

Thermal Testing

Thermal testing was performed on TIMs #1-4 according to ASTM D 5470 using the following application procedure: a 38 mm×38 mm (1.5 in.×1.5 in.) sheet of the thermal interface material on decal paper was placed face down on the cold block of the test apparatus. A thin film of water was deposited onto the decal paper and allowed to sit for 1 minute. The decal paper was then removed, exposing the top surface of the material. The heating block was placed on top of the material and pressure was applied using a pressurized air driven piston. The test results are shown in the table below.

TABLE 2

| | TIM #1 | TIM #2 | TIM #3 | TIM #4 |
|---|---|---|---|---|
| Thermal | 0.06 ° C.-in²/W | 0.07 ° C.-in²/W | 0.12 ° C.-in²/W | 0.15° C.-in²/W |
| Resistance | | | | |
| @ 30 psi | | | | |
| Thermal | 2.91 W/m-K | 2.67 W/m-K | 1.96 W/m-K | 1.44 W/m-K |
| Conductivity | | | | |
| @ 30 psi | | | | |
| Cone Penetration | 300 | 251 | 174 | 65 |
| Number | | | | |

Oil Migration Testing

Oil migration testing was performed according to ASTM C 772 using the following procedure: a 2.5 cm (1 in.) disk of the prepared TIM was cut from the decal paper coated sample and placed on a sheet of Whatman #1 filter paper. The oil migration was measured with calipers from the edge of the sample to the edge of the oil migration front. Samples of thermal grease were also tested for comparison. The data is shown in the Table 3 below. As can be seen, the oil migration of the silicone gum TIM is an order of magnitude less than that of thermal greases.

TABLE 3

| | Oil Migration Distance |
|---|---|
| Sample | After 30 Days |
| TIM #1 | 5.9 mm |
| TIM #2 | 4.1 mm |
| TIM #3 | 2.7 mm |
| TIM #4 | 0.6 mm |
| Techspray 1978 Thermal | 40 mm |
| Grease | |
| Thermalcote Thermal | 29 mm |
| Grease | |

### EXAMPLE NO. 5

SILICONE PRECURSOR #5—Part A

In a double planetary mixer, 48.95 parts vinyl-terminated PDMS (viscosity, 500 cps, molecular weight 13,000), 0.05 parts platinum-vinylsiloxane complex (2% Pt concentration), 50 parts by weight boron nitride powder with a median particle size of 100 microns, and 1 part silanol-terminated PDMS (viscosity, 100 cps) are combined. The components are mixed in the double planetary mixer with vacuum de-aeration for 20 minutes to form SILICONE PRECURSOR #5—Part A. The viscosity of PRECURSOR #5—Part A is measured using a Brookfield viscometer according to ASTM D 2196, Method A, spindle #7, 20 rpm and is 24,000 cps.

SILICONE PRECURSOR #5—Part B

In a double planetary mixer, 44.9 parts vinyl terminated PDMS (viscosity, 500 cps; molecular weight 13,000 amu), 4.05 parts hydride-terminated PDMS (viscosity, cps, molecular weight 500), 0.05 parts 3,5-dimethyl-1-hexyn-3-ol, 50 parts by weight boron nitride powder with a median particle size of 100 microns, and 1 part silanol-terminated PDMS (viscosity, 100 cps) are combined. The components are mixed in the double planetary mixer with vacuum de-aeration for 20 minutes to form SILICONE PRECURSOR #5—Part B. The viscosity of PRECURSOR #5—Part B is measured using a Brookfield viscometer according to ASTM D 2196, Method A, spindle #7, 20 rpm and is 17,900 cps.

Equal parts of PRECURSOR #5—Part A and PRECURSOR #5—Part B are mixed using a hand-held static mixer. The prepared material is coated on waterslide decal paper using a doctor blade coater to a nominal film thickness of 0.18 mm (0.007 in.). The film is cured at 90° C. for 5 minutes in a forced air circulating oven to form TIM #5. The thermal resistance and thermal conductivity of TIM #5 are measured according to ASTM D 5470 as described above. The resultant data is shown in Table 4 below. In addition, a sample of TIM #5 is prepared for cone penetration testing according to ASTM D 217 by mixing 50 parts PRECURSOR #5—Part A and 50 parts PRECURSOR #5—Part B in a plastic beaker with an overhead mixer for 3 minutes followed by vacuum de-aeration. The material is poured into a 200 cc metal container and cured at 90° C. for 60 minutes.

TABLE 4

| Performance | TIM #5 |
|---|---|
| Thermal Resistance @ 30 psi | 0.07 ° C.-in²/W |
| Thermal Conductivity @ 30 psi | 2.02 W/m-K |
| Cone Penetration Number | 235 |

### EXAMPLE NO. 6

SILICONE PRECURSOR #6

In a double planetary mixer, 46.92 parts vinyl-terminated PDMS (viscosity, 500 cps; molecular weight 13,000), 0.025 parts platinum-vinylsiloxane complex (2% Pt concentration), 2.03 parts hydride-terminated PDMS (viscosity, 3 cps; molecular weight, 500), 0.025 parts 3,5-dimethyl-1-hexyn-3-ol, 50 parts by weight boron nitride powder with a median particle size of 100 microns, and 1 part silanol-terminated PDMS (viscosity 100 cps) are combined. The components are mixed in the double planetary mixer with vacuum de-aeration for 20 minutes to form SILICONE PRECURSOR #6. The viscosity of PRECURSOR #6 is measured using a Brookfield viscometer according to ASTM D 2196, Method A, spindle #7, 20 rpm and is 21,300 cps. PRECURSOR #6 is coated on waterslide decal paper using a doctor blade coater to a nominal film thickness of 0.18 mm (0.007 in.). The film is cured at 90° C. for 5 minutes in a forced air circulating oven to form TIM #6. The thermal resistance and thermal conductivity of TIM #6 are measured according to ASTM D 5470 as described above. The data are shown in Table 5 below. A sample of TIM #6 is prepared for cone penetration testing according to ASTM D 217 by filling a 200 cc metal container with PRECURSOR #6 and then curing at 90° C. for 60 minutes in a forced air circulating oven.

TABLE 5

| Performance | TIM #6 |
|---|---|
| Thermal Resistance @ 30 psi | 0.07 ° C.-in²/W |
| Thermal Conductivity @ 30 psi | 2.26 W/m-K |
| Cone Penetration Number | 240 |

### EXAMPLE NO. 7

In a double planetary mixing bowl, 24.5 parts PRECURSOR #2—Part A and 24.5 parts PRECURSOR #2—Part B are combined. The components are mixed for 3 minutes. One part silanol-terminated PDMS (viscosity 100 cps) and 50 parts by weight boron nitride powder with a median particle size of 100 microns are added to this mixture. The components are mixed in the double planetary mixer with vacuum de-aeration for 20 minutes to form PRECURSOR #7. PRECURSOR #7 is coated onto waterslide decal paper using a doctor blade coater to a nominal film thickness of 0.18 mm (0.007 in.). The film is cured at 90° C. for 5 minutes in a forced air circulating oven to form TIM #7. The thermal resistance and thermal conductivity of TIM #7 are measured according to ASTM D 5470 as described above. The data are shown in the Table 6 below. A sample of TIM #7 also is prepared for cone penetration testing according to ASTM D 217 by pouring PRECURSOR #7 into a 200 cc metal container and curing the sample at 90° C. for 60 minutes.

TABLE 6

| Performance | TIM #7 |
|---|---|
| Thermal Resistance @ 30 psi | 0.07 ° C.-in²/W |
| Thermal Conductivity @ 30 psi | 2.27 W/m-K |
| Cone Penetration Number | 250 |

### EXAMPLE NO. 8

Twenty parts SILICONE #2—Part A and 80 parts aluminum metal powder with a median particle size of 3 microns are combined. The components are mixed with a double planetary mixer with vacuum de-aeration for 20 minutes to form PRECURSOR #8—Part A. The viscosity of PRECURSOR #8—Part A is measured using a Brookfield viscometer according to ASTM D 2196, Method A, spindle #7, 20 rpm and is 369,000 cps.

Twenty 20 parts of SILICONE #2—Part B is to added 80 parts aluminum metal powder with a median particle size of 3 microns. The components are mixed with a double planetary mixer with vacuum de-aeration for 20 minutes to form PRECURSOR #8—Part B. The viscosity of PRECURSOR #8—Part B is measured with a Brookfield viscometer according to ASTM D 2196, Method A, spindle #7, 20 rpm and is 379,000 cps.

Equal parts of PRECURSOR #8—Part A and PRECURSOR #8—Part B are mixed using a hand-held static mixer. The prepared material is coated onto waterslide decal paper using a doctor blade coater to a nominal film thickness of 0.18 mm (0.007 in.). The film is cured at 90° C. for 5 minutes in a forced air circulating oven to form TIM #8. The thermal resistance and thermal conductivity of TIM #8 are measured according to ASTM D 5470 as described above. The data are shown in the Table 7 below. A sample of TIM #8 also is prepared for cone penetration testing according to ASTM D 217 by mixing 50 parts PRECURSOR #8—Part A and 50 parts PRECURSOR #8—Part B in a plastic beaker with an overhead mixer for 3 minutes followed by vacuum de-aeration. The material is poured into a 200 cc metal container and cured in a forced air circulating oven at 90° C. for 60 minutes.

TABLE 7

| Performance | TIM #8 |
|---|---|
| Thermal Resistance @ 30 psi | 0.05 ° C.-in²/W |
| Thermal Conductivity @ 30 psi | 2.0 W/m-K |
| Cone Penetration Number | 334 |

It will be understood that embodiments covered by claims below will include any of the above compositions of matter, so long as the silicone gum polymers have a functionality of two or less. In addition, the methods of combining the components are also meant to be covered, whether the components are combined all at once, formed into a masterbatch for later compounding, or formed as a Part A and a Part B precursor, and then mixed.

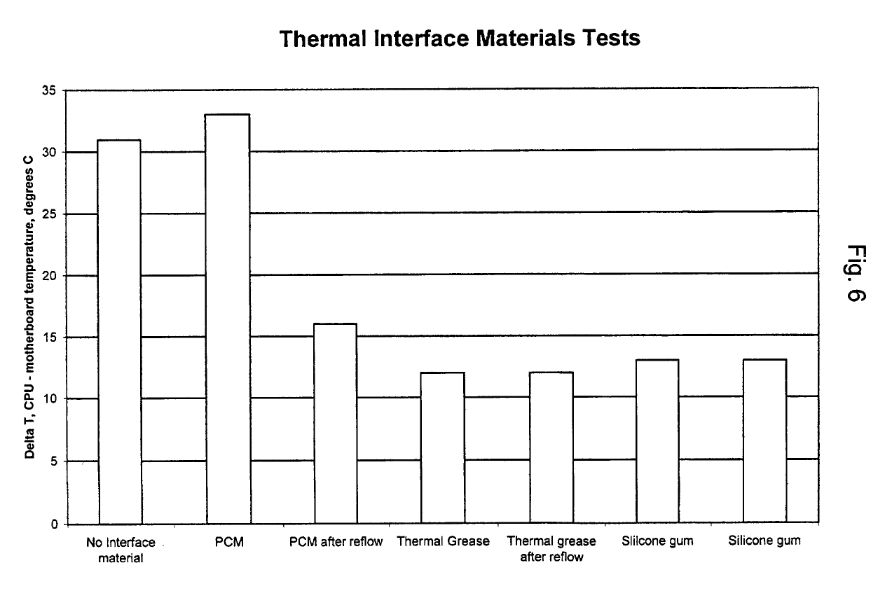

Performance of the thermal interface material of the present invention is compared in FIGS. 6-8. FIG. 6 depicts the temperature of an Intel Pentium® III CPU in contact with a pad shaped from the thermal interface material of the present invention. Silicone gum with 30 volume percent boron nitride was the most effective thermal interface material, and was achieved without thermal reflow.

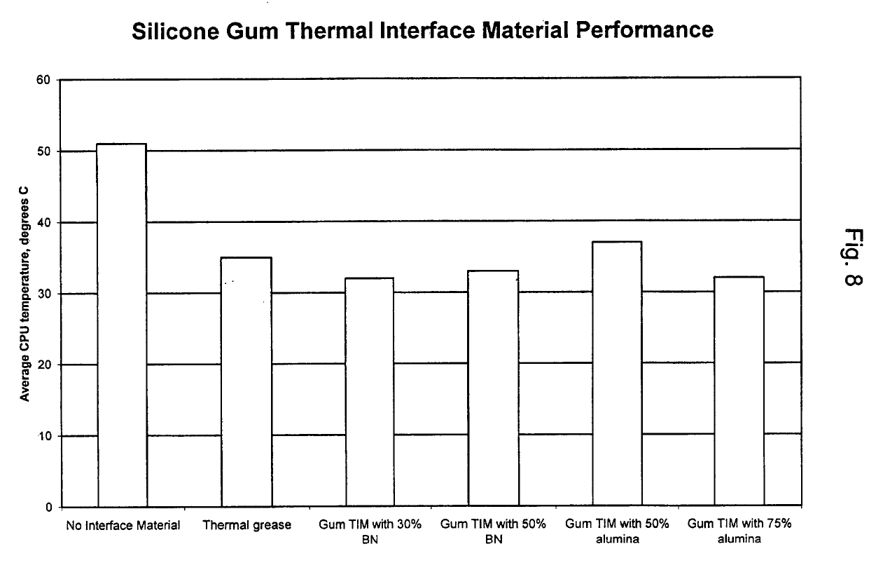

Pads for use on a CPU or other computer chip requiring heat transfer may be made directly from the mixture of materials by casting or forming in the ways described above. In addition, pads may be formed or shaped by secondary operations after the silicone materials are cured. The secondary operations are typically cutting or trimming the material to the precise desired shape. These operations may be performed manually, or the material may be cut by machine, as by die cutting, or other efficient, low-cost cutting or trimming operation, to shape the pads into the desired shape. FIG. 8 depicts CPU temperature with several interface materials, including different loadings of particulate material in the silicone gum based thermal interface material of the present invention. Silicone gum with 30% boron nitride had the best performance and the lowest-temperature CPU in these tests.

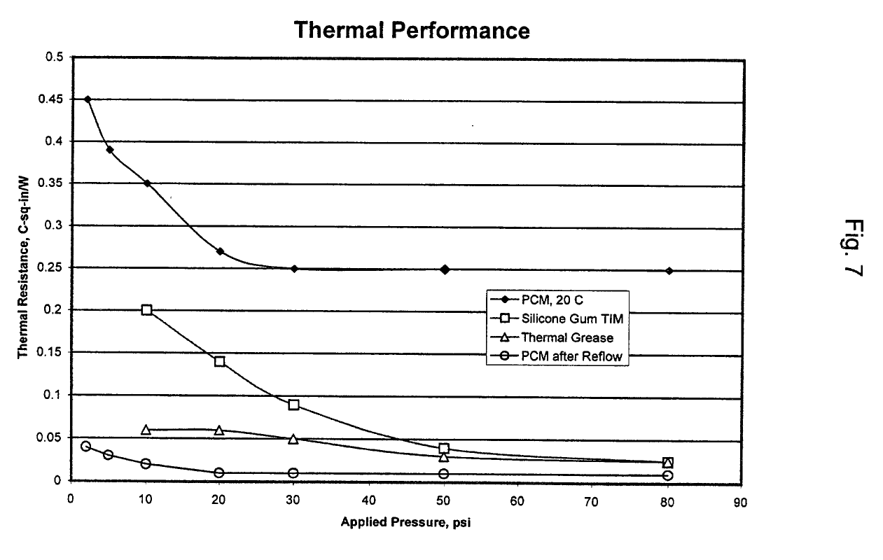

FIG. 7 depicts the performance of a variety of materials under different applied pressures. Clearly, the best thermal performance is achieved at the highest pressure, that is, when a pad shaped from the thermal interface material of the present invention is held most closely to the CPU backside. Phase change materials have very high thermal resistance without a reflow step, and thermal grease has about the same thermal resistance as the phase change material. The silicone gum based thermal interface material of the present invention performs as well as any of the other interface materials, but without the reflow step needed for PCMs or the oil migration problems of thermal grease.

Of course, in using the thermal interface materials described above, any of several improvements may be used in combination with others features, whether or not they were explicitly described as such. Various embodiments of the invention have been described and illustrated. However, the description and illustrations are by way of example only. Other embodiments and implementations are possible within the scope of this invention and will be apparent to those of ordinary skill in the art. Therefore, the invention is not limited to the specific details, representative embodiments, and illustrated examples in this description. Accordingly, the invention is not to be restricted except as necessitated by the accompanying claims and their equivalents.

What is claimed is:

1. A high viscosity, cured thermal interface material comprising:
from about thirty-three to about sixty-six parts by weight of a vinyl-terminated polydimethylsiloxane having a functionality of two or less;
from about one to about sixty-six parts by weight of a hydride terminated polydimethylsiloxane having a functionality of two or less;
from about zero to about twenty parts by weight of a coupling agent; and
from about zero to about two parts by weight of a catalyst.

2. The thermal interface material of claim 1, wherein the material is heat-cured.

3. The thermal interface material of claim 1, further comprising from about zero to about eighty parts by volume of a particulate thermally conductive material.

4. The thermal interface material of claim 1, wherein the catalyst is selected from the group consisting of tris-(dibutylsulfide) rhodium trichloride, platinum-octanaldehyde/octanol complex, platinum carbonyl cyclovinylmethylsiloxane complex, platinum-divinyltetramethyldisiloxane complex, chloroplatinic acid (Karsted's catalyst), and platinum-cyclovinylmethylsiloxane complex.

5. The thermal interface material of claim 3, wherein the thermally conductive material is selected from the group consisting of boron nitride, silica, aluminum oxide, zinc oxide, silicon powder, silicon nitride, silicon carbide, graphite, and metallic powder.

6. The thermally conductive material of claim 5, wherein the boron nitride has a median particle size of about one hundred micrometers, the aluminum oxide has a particle size of from about one micrometer to about sixty micrometers, and the metallic powder is aluminum having a particle size of from about one micrometer to about five micrometers.

7. The thermal interface material of claim 1, further comprising from about zero parts to about five parts by weight of a curing decelerator.

8. The thermal interface material of claim 7, wherein the decelerator is selected from the group consisting of diallyl maleate, 1,3-divinyltetramethyldisiloxane, 3,5-dimethyl-1-hexyn-3-ol, and 1,3,5,7-tetravinyl-1,3,5,7-tetramethylcyclotetrasiloxane.

9. The thermal interface material of claim 1, wherein the coupling agent is selected from the group consisting of silanol-terminated polydimethylsiloxane, a silane coupling agent, a titanate coupling agent, a zirconate coupling agent, and an organic acid coupling agent.

10. A high viscosity, cured silicone-based thermal interface material, comprising:
from about thirty-three to about sixty-six parts by weight of a vinyl-terminated polydimethylsiloxane having a functionality of two or less;
from about one to about sixty-six parts by weight of a hydride-terminated polydimethylsiloxane having a functionality of two or less;
from about zero to about twenty parts by weight of a coupling agent; and
from about zero to about two parts by weight of platinum-divinyltetramethyldisiloxane complex catalyst.

11. The thermal interface material of claim 10, wherein said material is heat-cured.

12. The thermal interface material of claim 10, further comprising from about zero to about eighty parts by volume of a particulate thermally conductive material.

13. The thermal interface material of claim 12, wherein the thermally conductive material is selected from the group consisting of boron nitride, silica, aluminum oxide, zinc oxide, silicon powder, silicon nitride, silicon carbide, graphite, and metallic powder.

14. The thermal interface material of claim 13, wherein the boron nitride has a median particle size of about one hundred micrometers, the aluminum oxide has a particle size of from about one micrometer to about sixty micrometers, and the metallic powder is aluminum having a particle size of from about one micrometer to about five micrometers.

15. The thermal interface material of claim 10, further comprising from about zero parts to about five parts by weight of 3,5-dimethyl-1-hexyn-3-ol.

16. The thermal interface material of claim 10, wherein the coupling agent is selected from the group consisting of a silanol-terminated polydimethylsiloxane, a silane coupling agent, a titanate coupling agent, a zirconate coupling agent, and an organic acid coupling agent.

17. A method of making a silicone-based thermal interface material, the method comprising:
providing from about thirty-three to about sixty-six parts by weight of a vinyl-terminated polydimethylsiloxane having a functionality of two or less;
providing from about one to about sixty-six parts by weight of a hydride terminated polydimethylsiloxane having a functionality of two or less;
providing from about zero to about twenty parts by weight of a coupling agent;
providing from about zero parts to about five parts by weights of a curing decelerator;
providing from about zero to about two parts by weight of a catalyst;
combining said vinyl-terminated polydimethylsiloxane, said hydride terminated polydimethylsiloxane, said coupling agent, said curing decelerator, and said catalyst to form a mixture;
forming a film from the mixture; and
curing the film.

18. The method of claim 17, further comprising shaping the cured film into at least one pad.

19. The method of claim 17, wherein the film is from about 0.001 to about 0.020 inches thick.

20. The method of claim 17, wherein the film is cured at a temperature from about 20° C. to about 150° C.

21. The method of claim 17, further comprising providing a thermally conductive material in a volume fraction of from about zero percent to about eighty percent.

22. The method of claim 17, wherein at least a portion of the vinyl-terminated polydimethylsiloxane and the catalyst are mixed together in a first container prior to the combining step, and at least a portion of the vinyl-terminated polydimethylsiloxane and the hydride-terminated polydimethylsiloxane are mixed together in a second container prior to the combining step.

23. The method of claim 22, wherein at a least a portion of the curing decelerator is mixed with the vinyl-terminated polydimethylsiloxane and the hydride-terminated polydimethylsiloxane in the second container.

24. The method of claim 22, further comprising adding a thermally conductive material and a coupling agent to the vinyl-terminated polydimethylsiloxane and the catalyst in the first container.

25. The method of claim 22, further comprising adding a thermally conductive material and a coupling agent to the first or second container.

26. The method of claim 17, wherein at least a portion of the vinyl-terminated polydimethylsiloxane, at least a portion of the catalyst, and at least a portion of the coupling agent are mixed together in a first container prior to the combining step, and at least a portion of the hydride-terminated polydimethylsiloxane, at least a portion of the curing decelerator, and at least a portion of the coupling agent are mixed in a second container prior to the combining step.

27. The method of claim 26, wherein a thermally conductive material is added to the first or second container prior to the combining step.

28. The method of claim 17, wherein the method of forming the film is selected from the group consisting of casting, compression molding, blading, doctor blading, printing, spreading, and dispensing.

29. The method of claim 17, further comprising vacuum de-aerating the mixture after the combining step.
